(19) United States
(12) Patent Application Publication
(10) Pub. No.: US 2008/0244102 A1
(43) Pub. Date: Oct. 2, 2008

(54) Identifier assigning device, identifier assigninig system and computer readable medium

(75) Inventor: Akiko Mochizuki, Kanagawa (JP)

Correspondence Address: OLIFF & BERRIDGE, PLC, P.O. BOX 320850, ALEXANDRIA, VA, 22320-4850, US

(73) Assignee: FUJI XEROX CO,. LTD., TOKYO (JP)

(21) Appl. No.: 11/976,411

(22) Filed: Oct. 24, 2007

(30) Foreign Application Priority Data
Mar. 30, 2007 (JP) 2007-095107

(51) Int. Cl. G06F 3/00

(52) U.S. Cl. 710/9

(57) ABSTRACT

An identifier assigning device includes an accepting section, a releasing section and an assigning section. The accepting section accepts a request from a first equipment for assigning an identifier of a first type to the first equipment. The first equipment is configured to communicate using an identifier of the first type. The releasing section releases an identifier of the first type assigned to a second equipment. An identifier of a second type is also assigned to the second equipment. The second equipment is configured to communicate using any of (i) the identifier of the first type assigned to the second equipment and (ii) the identifier of the second type assigned to the second equipment. The assigning section that assigns the identifier of the first type released from the second equipment by the releasing section, to the first equipment from which the accepting section accepts the request.

### CROSS-REFERENCE TO RELATED APPLICATIONS

This application is based on and claims priority under 35 USC 119 from Japanese Patent Application No. 2007-095107 filed Mar. 30, 2007.

### BACKGROUND

1. Technical Field

The present invention relates to an identifier assigning device, an identifier assigning system, and a computer readable medium.

2. Related Art

The IPv6 (Internet Protocol Version 6) is spreading recently, and many equipments can get the IP address in contrast to the conventional network environment using the conventional IPv4 (Internet Protocol Version 4). Therefore, such a situation is expected that, in the network environment such as LAN (Local Area Network), and the like, the opportunity to hold communication according to the IP will arise more frequently than the present situation.

In contrast, most of the conventional equipments can communicate according to the IPv4 only. In order to utilize effectively these equipments, these equipments are used in the mixed network includes the equipment capable of holding communication according to the IPv4 only and the dual-stack equipment capable of holding communication according to both IPv4/IPv6. At that time, respective IP addresses are assigned to the equipment that can communicate based on both IPv4/IPv6, while only the IPv4 address is assigned to the equipment that can communicate based on the IPv4 only. As the IP address assigning method, there is the method of assigning the IP address automatically by using the DHCP (Dynamic Host Configuration Protocol) server.

In the above IPv4/IPv6 mixed network, in case a large number of equipments are connected to the network, it is not feared that the IPv6 address is exhausted, but in some cases the IPv4 address is exhausted. In such case, the equipment that can communicate based on the IPv4 only cannot get the IPv4 address and is brought into such a condition that the equipment cannot hold the communicate using the IP.

In such circumstances, as the technology to prevent the exhaustion of the IPv4 address, DSTM (Dual Stack Transition Mechanism) exists. In the IPv6 network, the DSTM is constructed by the DSTM server, the IPv4/IPv6 dual stack equipment, the tunneling router, etc. In case the IPv4/IPv6 dual stack equipment intends to communicate with the IPv4 equipment, this equipment gets the IPv4 address temporarily to form the IPv4-over-IPv6 tunnel to the router. Then, the router converts the data into the IPv4 packet and transfers this packet to the target IPv4 equipment.

### SUMMARY

According to an aspect of the invention, an identifier assigning device includes an accepting section, a releasing section and an assigning section. The accepting section accepts a request from a first equipment for assigning an identifier of a first type to the first equipment. The first equipment is configured to communicate using an identifier of the first type. The releasing section releases an identifier of the first type assigned to a second equipment. An identifier of a second type is also assigned to the second equipment. The second equipment is configured to communicate using any of (i) the identifier of the first type assigned to the second equipment and (ii) the identifier of the second type assigned to the second equipment. The assigning section that assigns the identifier of the first type released from the second equipment by the releasing section, to the first equipment from which the accepting section accepts the request.

### BRIEF DESCRIPTION OF THE DRAWINGS

Exemplary embodiments of the present invention will be described in detail based on the following figures, wherein:

FIG. 1 is a system configurative view showing an example of an identifier assigning system according to a first exemplary embodiment;

FIG. 2 is a block diagram showing an example of an identifier assigning device according to the first exemplary embodiment;

FIG. 3 is a functional block diagram showing an example of the identifier assigning device according to the first exemplary embodiment;

FIG. 4 is a flowchart showing an example of an operation of the identifier assigning device according to the first exemplary embodiment;

FIG. 5 is a system configurative view showing an example of an identifier assigning system according to a second exemplary embodiment;

FIG. 6 is a functional block diagram showing an example of the identifier assigning device according to the second exemplary embodiment;

FIG. 7 is a flowchart showing an example of an operation of the identifier assigning device according to the second exemplary embodiment;

FIGS. 8A and 8B are a functional block diagram showing an example of an identifier assigning device according to a third exemplary embodiment, and a conceptual view showing an example of a reservation management table;

FIG. 9 is a flowchart showing an operational example of a reservation process of the identifier assigning device according to the third exemplary embodiment;

FIG. 10 is a flowchart showing an operational example of a reservation assigning process 1 of the identifier assigning device according to the third exemplary embodiment;

FIG. 11 is a flowchart showing an operational example of a reservation assigning process 2 of the identifier assigning device according to the third exemplary embodiment;

FIG. 12 is a flowchart showing an operational example of an extension denying process 3 of the identifier assigning device according to the third exemplary embodiment;

FIG. 13 is a functional block diagram showing an example of an identifier assigning device according to a fourth exemplary embodiment;

FIG. 14 is a flowchart showing an example of an operation of the identifier assigning device according to the fourth exemplary embodiment;

FIG. 15 is a functional block diagram showing an example of an identifier assigning device according to a fifth exemplary embodiment;

FIG. 16 is a flowchart showing an example of an operation of the identifier assigning device according to the fifth exemplary embodiment;

FIG. 17 is a flowchart showing an example of an operation of an identifier assigning device according to a sixth exemplary embodiment.

FIG. 18 is a flowchart showing an example of an operation of an identifier assigning device according to a seventh exemplary embodiment.

### DETAILED DESCRIPTION

Exemplary embodiments of the present invention will be explained with reference to the drawings hereinafter.

### 1. First Exemplary Embodiment

An identifier assigning device in the first exemplary embodiment has a function of releasing the IPv4 address of the equipment to which the IPv4 address has been assigned and which can also communicate by the IPv6 and then assigning the IPv4 address to the sender-of-request equipment when a request for assignment of the IPv4 address is made by the equipment that can communicate by the IPv4 only in a situation that the assignable IPv4 address is exhausted.

Here, the identifier signifies the information used to identify uniquely each of communication equipments in the network that includes plural communication equipments. For example, the identifier is the IP address in the IP (Internet Protocol) of the network layer in the OSI reference model (open system interconnecting reference model). At present, the IPv4 and the IPv6 exist in the IP, and it is impossible for the equipment that can communicate over the IPv4 network only and the equipment that can communicate over the IPv6 network only to communicate mutually.

### Configuration of First Exemplary Embodiment

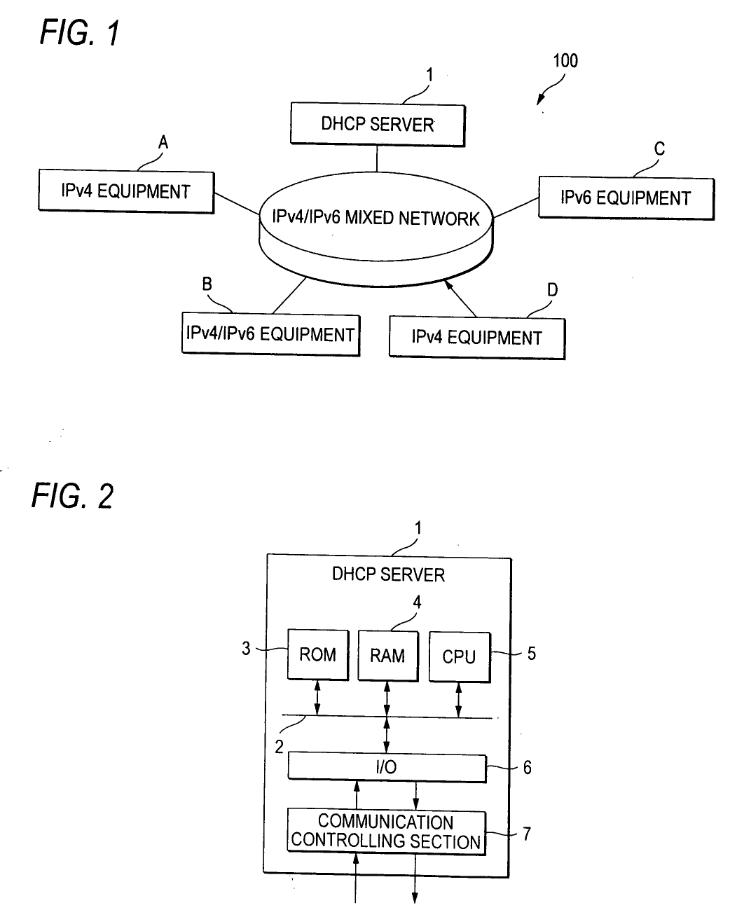

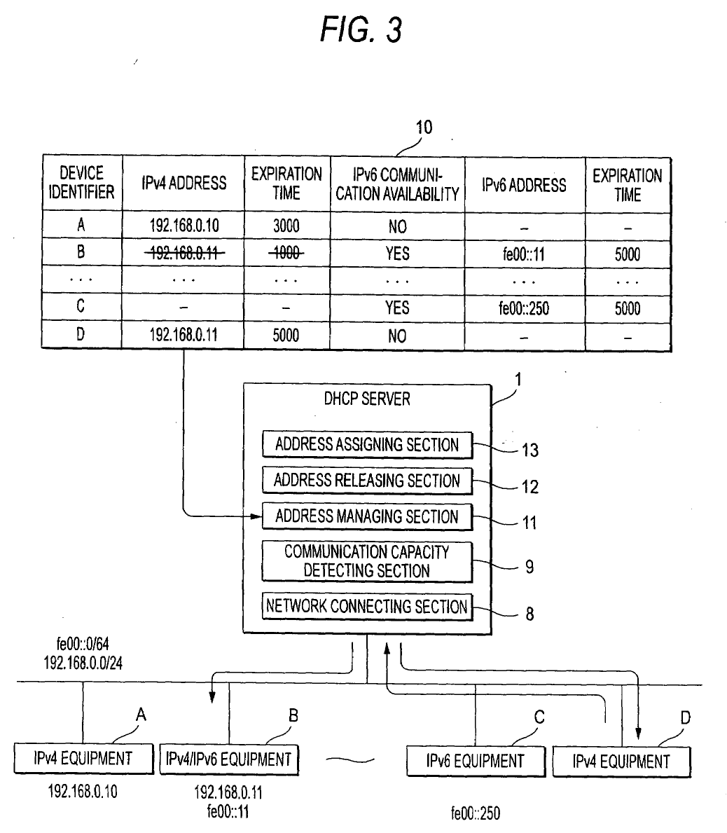

Next, configurative examples of the identifier assigning system and the identifier assigning device will be explained in detail with reference to FIG. 1 to FIG. 3 hereinafter. FIG. 1 is a system configurative view showing an example of the identifier assigning system. FIG. 2 is a block diagram showing an example of the identifier assigning device. FIG. 3 is a functional block diagram showing an example of the identifier assigning device.

### (1) Identifier Assigning System

An identifier assigning system 100 shown in FIG. 1 provides the network system in which the equipments that can communicate using the IPv4 address and/or the IPv6 address are mixed together and communication can be held according to either of both protocols. The identifier assigning system 100 is constructed by an IPv4 equipment A, an IPv4/IPv6 equipment B, an IPv6 equipment C, and a DHCP server 1 as an example of an identifier assigning device. Also, although not shown, this network is connected to other networks by using an IPv4/IPv6-compatible router as a gateway.

The IPv4 equipment A and the IPv4 equipment D are the equipment that can communicate using the IPv4 address only, and the IPv4/IPv6 equipment B is the equipment that can communicate by either of the IPv4/IPv6 addresses. The IPv6 equipment C is the equipment that can communicate by the IPv6 only. These equipments are a PC (Personal Computer), a notebook PC, a server, a printer, a scanner, a facsimile, and other communication equipments, for example.

These five equipments are illustrated in this identifier assigning system 100, but the number of equipments is not limited to this number. The system may be constructed by several hundred equipments or several thousand equipments, for example. Also, LAN or WAN (Wide Area Network) for connecting LANs may be employed as an IPv4/IPv6 mixed network, and both cable and radio may be employed.

### (2) Identifier Assigning Device

The DHCP server 1 is an example of the identifier assigning device. This DHCP server 1 has a function of receiving a request for assignment of the IPv4 address from plural equipments connected to the network and then assigning the IPv4 address and the IPv6 address not to overlap mutually. Here, the server having a function of assigning only the IPv4 address may be employed. In this case, the IPv6 address is assigned by another communication equipment such as a router, or the like.

Also, the DHCP server 1 has a function of releasing the IPv4 address assigned to the dual stack communication equipment, which can communicate using either of the IPv4/IPv6 addresses, and then assigning this IPv4 address to the sender-of-request equipment when a request for assignment of the IPv4 address is made in a situation that the assignable IPv4 address is exhausted.

An example of the hardware configuration of the DHCP server 1 will be explained with reference to FIG. 2 hereunder. The DHCP server 1 has a bus 2, a ROM (Read Only Memory) 3, a RAM (Random Access Memory) 4, a CPU (Central Processing Unit) 5, an I/O (input/output device) 6, and a communication controlling section 7.

The bus 2 is a signal line for connecting the ROM3, the RAM 4, the CPU 5, and the I/O 6 mutually, and data and control signals are transmitted over this bus based on a predetermined clock frequency. The ROM3 is a nonvolatile auxiliary memory device for storing programs and data. For example, there are the EEPROM (Electrically Erasable and Programmable Read Only Memory), the hard disk drive, and the like.

The RAM 4 is a volatile main memory device, and the DRAM (Dynamic RAM) may be utilized, for example. The CPU 5 reads appropriately necessary programs and data from the RAM 4, and the RAM 4 is used as a working area of the arithmetic process in the CPU 5. The CPU 5 is the integrated circuit in which the arithmetic circuit, the control circuit, the register, and the like made of the logical circuit are provided. The CPU 5 inputs appropriately necessary programs and data from the RAM 4 to the register, performs the arithmetic process, and outputs the arithmetic result to the RAM 4 or the I/O 6. Also, the CPU 5 executes the interrupt control to input/output appropriately necessary data into/from the I/O 6.

The I/O 6 is the input/output integrated circuit for inputting/outputting the data into/from the communication controlling section 7 to transfer necessary data between the communication controlling section 7 and the CPU 5. The communication controlling section 7 is constructed by plural integrated circuits, and has functions of the physical layer and the data link layer in the OSI reference model. The communication controlling section 7 is the Ethernet (registered trademark) controller, for example. This communication controlling section 7 identifies respective equipments between adjacent nodes by the MAC address (Media Access Control address) of each equipment connected the network, and controls the transfer of the carrier wave between adjacent nodes based on the CSMA/CD (Carrier Sense Multiple Access/Collision Detection) system. The communication controlling section 7 may provide the functions of IEEE802.11 as the wireless LAN standard, FDDI (Fiber Distributed Data Interface), PPP (Point-to-Point Protocol), etc. in addition to the Ethernet (registered trademark).

An example of the software configuration of the DHCP server 1 will be explained with reference to FIG. 3 hereunder. The DHCP server 1 has the softwares including a network connecting section 8, a communication capacity detecting section 9, an address managing section 11, an address releasing section 12, an address assigning section 13, and the like. The softwares except the communication controlling section 7 are stored in the ROM 3 shown in FIG. 2.

The network connecting section 8 takes charge of the network layer and the transport layer in the OSI reference model, and has a function of transmitting/receiving the data by using the DHCP and the UDP (User Datagram Protocol). The network connecting section 8 (an example of an accepting section) receives a request for address assignment from respective equipments connected to the network, and performs a series of communication procedures of DHCP message until assignment information is replied.

The communication capacity detecting section 9 (an example of a second detecting section) detects whether or not the equipment that requests the address assignment can communicate by the IPv4 and the IPv6. That is, the communication capacity detecting section 9 detects whether or not such equipment can hold the IPv6 communication, based on information in the message of the request for address assignment. In this case, the communication capacity detecting section 9 may inquire of the sender-of-request equipment on the spot whether or not such equipment can hold the IPv6 communication. Also, the communication capacity detecting section 9 may detect whether or not such equipment can hold the IPv6 communication, by capturing the packet being broadcasted. The detected information indicating whether or not such equipment can hold the IPv6 communication is registered in an address management table 10 based on the instruction from address managing section 11.

The address management table 10 contains information of the device identifier of respective equipments connected to the network, the IPv4 address assigned to respective equipments, the expiration time of the IPv4 address, an IPv6 communication availability, the IPv6 address, the expiration time of the IPv6 address, etc. The device identifier is the MAC address, UUID (Universal Unique Identifier), or the like, for example. The DHCP server 1 decides the expiration time based on the request from the client. In this example, the expiration time is set to 5000 minutes (about three days) at a maximum by the user as an initial value. Normally respective equipments connected to the network request an extension of the expiration time to the DHCP server before the expiration time expires.

The address managing section 11 (an example of a managing section) manages insertion, deletion, update, search, etc. of the row in the address management table 10. For example, the address managing section 11 (an example of a determining section) decides whether or not the assignable IPv4 address remains, by searching the address management table 10. In this case, a list of the assignable IPv4 addresses may be stored as another table, and the address managing section 11 may check appropriately whether or not a free IPv4 address is there. Also, the address managing section 11 (an example of a first detecting section) detects the equipment to which the IPv4 address has been assigned and which can communicate using the IPv6 address based on the address management table 10.

The address releasing section 12 (an example of a releasing section) releases the IP address and the expiration time when a request for release of the IP address is issued. Concretely, the address releasing section 12 makes a request to the address managing sections 11 to delete the IP address and the expiration time from the address management table 10.

The address assigning section 13 (an example of a assigning section) assigns either of IP addresses to the equipment that can communicate using either of the IPv4 address and the IPv6 address, and assigns both of IP addresses to the equipment that can communicate by both IPv4/IPv6. Concretely, the address assigning section 13 makes a request to the address managing section 11 to delete the IP address (or addresses) and the expiration time (or expiration time) from the address management table 10.

### Operation of First Exemplary Embodiment

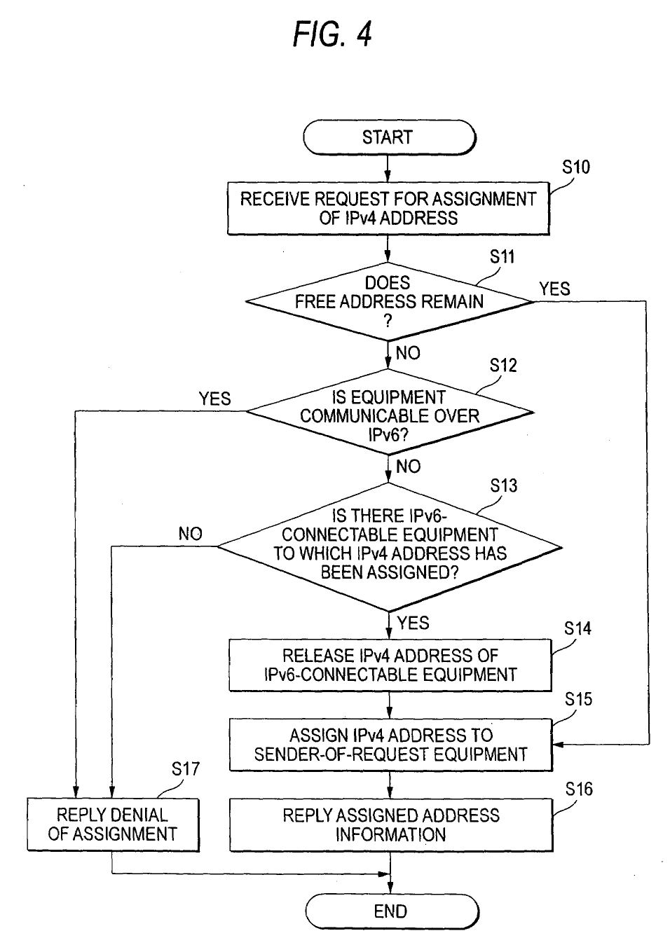

FIG. 4 is a flowchart showing an example of an operation of the identifier assigning device. An example of the operation will be explained with reference to FIG. 3 and FIG. 4 hereunder.

The network shown in FIG. 3 is the IPv4/IPv6 mixed network including of 192.168.0.0/24, f00::0/64. The DHCP server 1 sets 191 IPv4 addresses from 192.168.0.10 to 192.168.0.200 as a range of the automatic assignment. Assume that all IPv4 addresses have already been assigned completely.

In this situation, an IPv4 equipment D is newly added to the network, and a DHCP client program of the IPv4 equipment D starts to request the assignment of the IPv4 address of the DHCP server 1.

### (3) Identifier Assigning Program

The network connecting section 8 receives a packet for requesting the assignment of the IPv4 address from the IPv4 equipment D (step S10). Then, the address managing section 11 checks whether or not a free IPv4 address remains, by searching the address management table 10 (step S11). Because no assignable IPv4 address is found, the communication capacity detecting section 9 detects whether or not the IPv4 equipment D can hold the IPv6 communication, based on the request packet (step S12). Otherwise, the communication capacity detecting section 9 inquires of the IPv4 equipment D on the spot whether or not such equipment can hold the IPv6 communication.

Because the IPv4 equipment D cannot communicate using the IPv6 address, the address managing section will searches the equipment to which the IPv4 address has been assigned and which can hold the IPv6 communication (step S13). According to the address management table 10, the equipment to which the IPv4 address has been assigned and which can hold the IPv6 communication is the IPv4/IPv6 equipment B having the device identifier B. Therefore, the address releasing section 12 releases the IPv4 address=192.168.0.11 and the expiration time=1000 (deletes them from the address management table 10) (step S14).

Also, the address assigning section 13 assigns the released IPv4 address=192.168.0.11 and the expiration time=5000 to the IPv4 equipment D as the sender-of-request equipment (registers them on the address management table 10) (step S15). The network connecting section 8 replies the assigned address information to the IPv4 equipment D as the sender-of-request equipment (step S16).

In this case, immediately after step S13 but before the address releasing section 12 releases the IPv4 address of the IPv4/IPv6 equipment B, the address releasing section 12 (an example of an inquiring section) inquires whether or not the IPv4 equipment D needs the IPv4 address. Alternately, before the address releasing section 12 releases the IPv4 address of the IPv4/IPv6 equipment B, the address releasing section 12 may inquire whether or not the IPv4 equipment D is holding the IPv4 communication. Otherwise, before the address releasing section 12 releases the IPv4 address of the IPv4/IPv6 equipment B, the address releasing section 12 (an example of an inquiring section) may inquire the traffic by the IPv4.

Also, the address releasing section 12 decides whether or not the IPv4 address of other equipment should be released, based on the inquired result.

In this case, subsequent to step S13, the address releasing section 12 (an example of a notifying section) may notify the IPv4/IPv6 equipment B of the effect that the IPv4 address of the IPv4/IPv6 equipment B has been released after it released the IPv4 address of the IPv4/IPv6 equipment B. For example, the address releasing section 12 notifies the IPv4/IPv6 equipment B that “the IPv4 communication is stopped because there is not enough IPv4 address”, or the like.

In this case, this program and programs in following exemplary embodiments can be provided of course by the communicating section, and may be stored in the memory medium such as CD-ROM, or the like and then provided.

### 2. Second Exemplary Embodiment

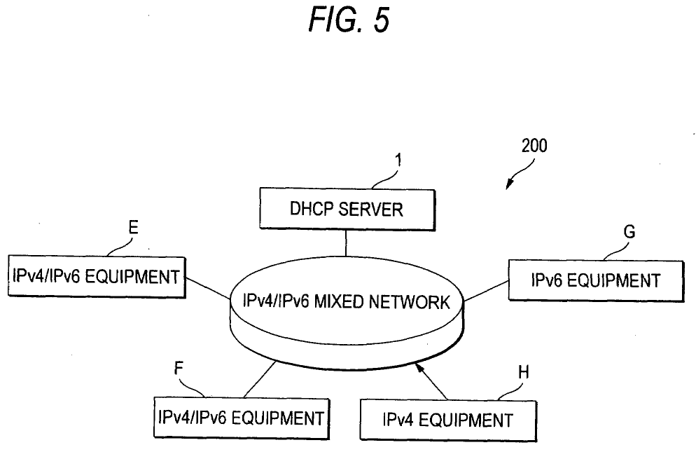

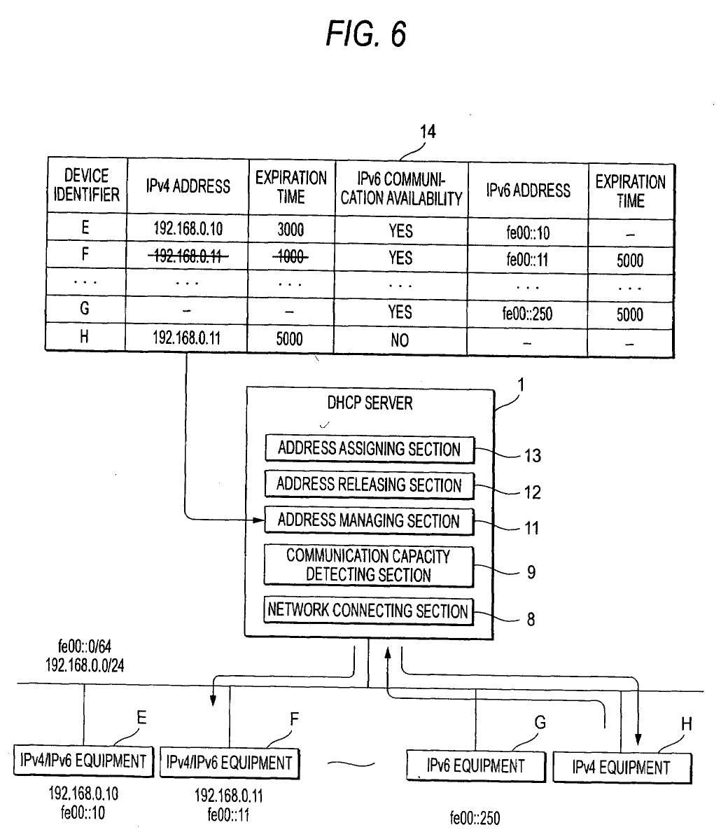

An identifier assigning device in the second exemplary embodiment has a function capable of releasing the IPv4 address of the equipment to which the IPv4 address has been assigned and which has the shortest term of the expiration time of the IP address among the IPv6 communicable equipments, and then assigning the IPv4 address to the sender-of-request equipment when a request for assignment of the IPv4 address is made by the equipment that can communicate only by the IPv4 in a situation that the assignable IPv4 address is exhausted. An example of the configuration of the identifier assigning system and the identifier assigning device will be explained with reference to FIG. 5 and FIG. 6 hereunder.

### Configuration of Second Exemplary Embodiment

FIG. 5 is a system configurative view showing an example of the identifier assigning system.

### (1) Identifier Assigning System

An identifier assigning system 200 shown in FIG. 5 provides the network system in which the equipments that can communicate using the IPv4 address and/or the IPv6 address are mixed together and communication can be held according to either of both protocols. The identifier assigning system 200 includes plural equipments that can communicate by both the IPv4/IPv6, and is constructed by an IPv4/IPv6 equipment E, an IPv4/IPv6 equipment F, an IPv6 equipment G, and the DHCP server 1 as an example of the identifier assigning device. In this case, the identifier assigning system 200 may include the equipment that can communicate by the IPv4 only, and the number of equipments is not limited to the number.

### (2) Identifier Assigning Device

The DHCP server 1 acting as an example of the identifier assigning device is implemented by the hardware configuration in FIG. 2 and the software configuration in FIG. 3.

### Operation of Second Exemplary Embodiment

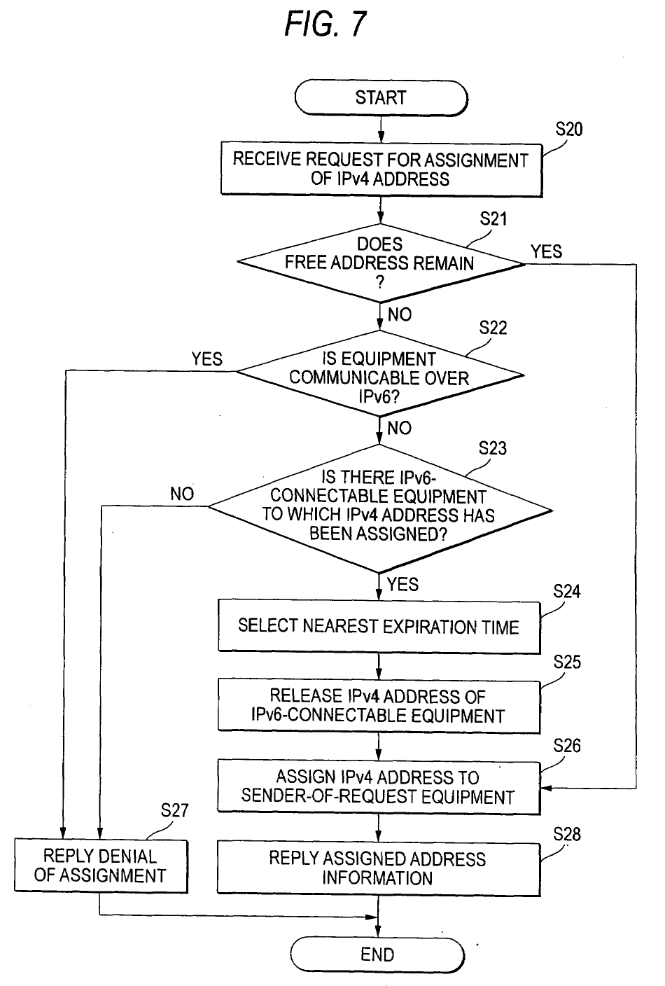

FIG. 6 is a functional block diagram showing an example of the identifier assigning device. FIG. 7 is a flowchart showing an example of an operation of the identifier assigning device. An example of the operation will be explained with reference to FIG. 6 and FIG. 7 hereunder.

The network shown in FIG. 6 provides the IPv4/IPv6 mixed network like that in FIG. 3. The DHCP server 1 sets 191 IPv4 addresses from 192.168.0.10 to 192.168.0.200 as a range of the automatic assignment. Assume that all IPv4 addresses have already been assigned completely.

In this situation, an IPv4 equipment H is newly added to the network, and a DHCP client program of the IPv4 equipment H starts to request the assignment of the IPv4 address of the DHCP server 1.

### (3) Identifier Assigning Program

The network connecting section 8 receive a packet for requesting the assignment of IPv4 address from the IPv4 equipment H (step S20). Then, the address managing section 11 checks whether or not a free IPv4 address remains, by searching the address management table 10 (step S21). Because no assignable IPv4 address is found, the communication capacity detecting section 9 detects whether or not the IPv4 equipment H can hold the IPv6 communication, based on the request packet (step S22).

Because the IPv4 equipment H cannot communicate by the IPv6, the address managing section 11 searches the equipment to which the IPv4 address has been assigned and which can hold the IPv6 communication (step S23). According to the address management table 14, the equipments to which the IPv4 address has been assigned and which can hold the IPv6 communication are both the IPv4/IPv6 equipment E having the device identifier E and the IPv4/IPv6 equipment F having the device identifier F. Therefore, the address managing section 11 selects the equipment of the address whose expiration time is nearest among these equipments (the IPv4/IPv6 equipment F) (step S24).

Then, the address releasing section 12 releases the IPv4 address of the IPv4/IPv6 equipment F=192.168.0.11 and the expiration time=1000 (deletes them from the address management table 10) (step S25). Also, the address assigning section 13 assigns the released IPv4 address=192.168.0.11 and the expiration time=5000 to the IPv4 equipment H as the sender-of-request equipment (registers them on the address management table 10) (step S26).

The network connecting section 8 replies the assigned address information to the IPv4 equipment H as the sender-of-request equipment (step S28).

### 3. Third Exemplary Embodiment

An identifier assigning device in the third exemplary embodiment reserves the IPv4 address of the equipment, which has the nearest expiration time of the address among the equipments to which the IPv4 address has been assigned and which can communicate by the IPv6, for the sender-of-request equipment (reserving process) when a request for assignment of the IPv4 address is made by the equipment that can communicate by the IPv4 only in a situation that the assignable IPv4 address is exhausted. Then, the identifier assigning device has a function of changing the destination of assignment to the sender-of-request equipment after the expiration time of the reserved IPv4 address passed (reservation assigning process).

### Configuration of Third Exemplary Embodiment

### (1) Identifier Assigning System

The identifier assigning system is implemented by the configuration in FIG. 1 or FIG. 5.

### (2) Identifier Assigning Device

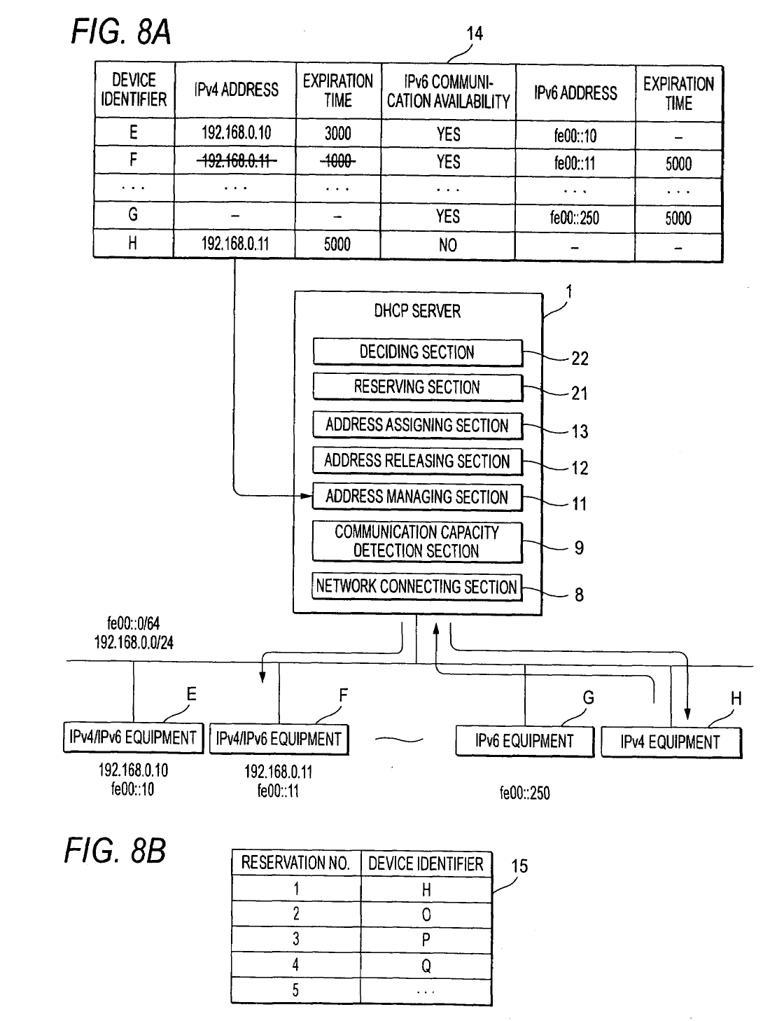

FIG. 8A is a functional block diagram showing an example of the identifier assigning device, and FIG. 8B is a conceptual view showing an example of a reservation management table. The hardware configuration of the identifier assigning device is implemented by the configuration of the DHCP server 1 in FIG. 2. Also, a DHCP server 20 shown in FIG. 8A has a reserving section 21, a deciding section 22 (an example of a judging section) and a reservation management table 15.

The reserving section 21 reserves the IPv4 address of the equipment, which has the nearest expiration time of the IPv4 address among the equipments to which the IPv4 address has been assigned and which can communicate by the IPv6, for the sender-of-request equipment when the request for assignment of the IPv4 address is made by the equipment that can communicate by the IPv4 only in a situation that the assignable IPv4 address is exhausted. The reserving section 21 registers the sender-of-request equipment on the reservation management table 15. The reservation management table 15 is constructed by the reservation No. indicating the reservation order, and the device identifier.

The deciding section 22 decides whether or not the expiration time of the IPv4 address assigned to the equipment that can communicate using the reserved IPv4 address passed.

### Operation of Third Exemplary Embodiment

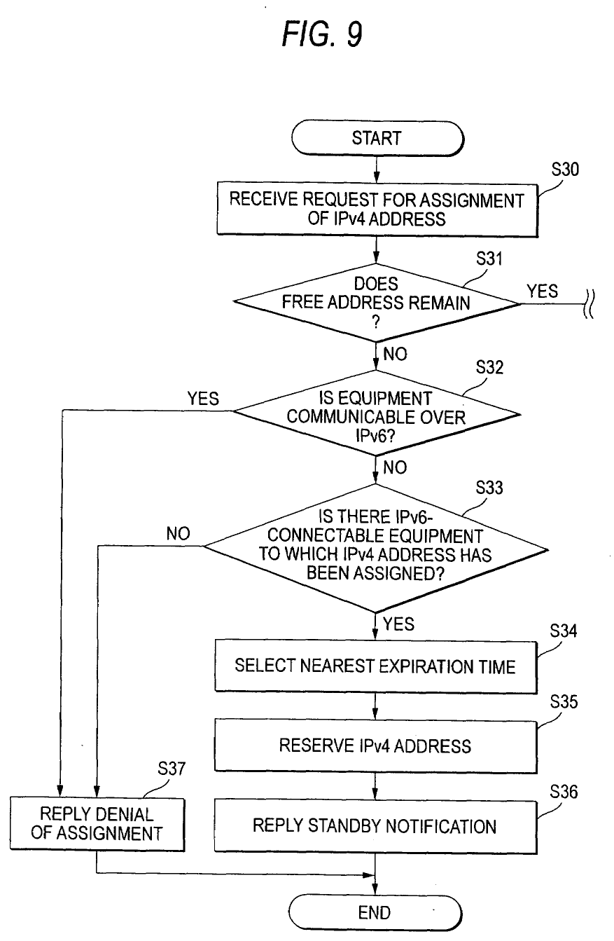

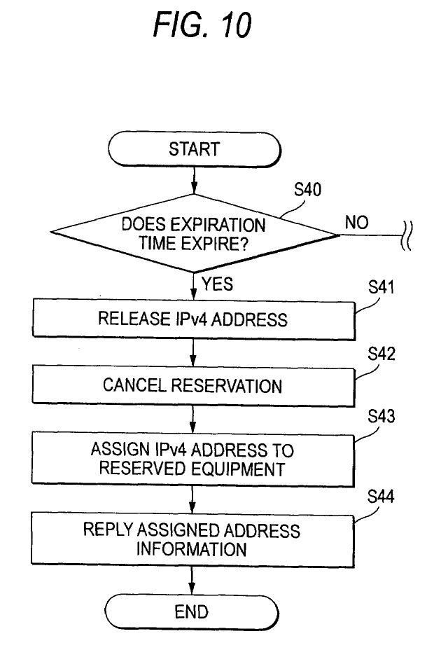

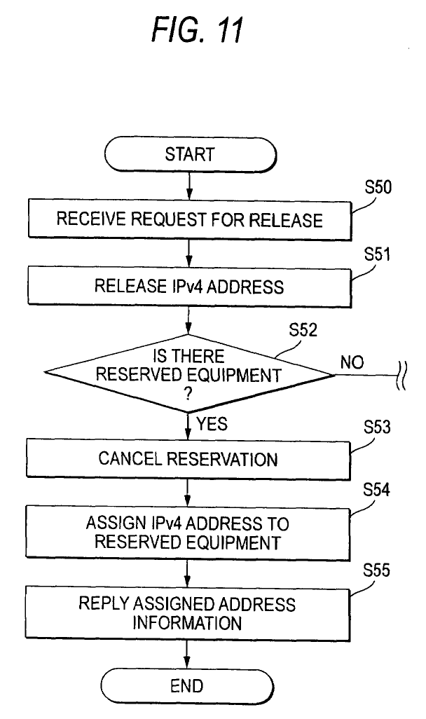

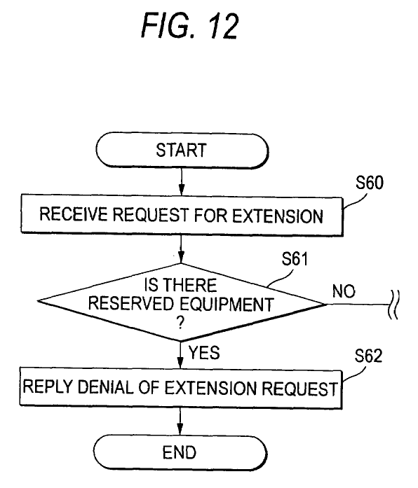

FIG. 9 is a flowchart showing an operational example of a reservation process of the identifier assigning device. FIG. 10 is a flowchart showing an operational example of a reservation assigning process 1 of the identifier assigning device. FIG. 11 is a flowchart showing an operational example of a reservation assigning process 2 of the identifier assigning device. FIG. 12 is a flowchart showing an operational example of an extension denying process 3 of the identifier assigning device. An example of the operation will be explained with reference to FIG. 8 to FIG. 12 hereunder.

Assume that all IPv4 addresses have already been assigned completely by the DHCP server 20. In such circumstance, the IPv4 equipment H is newly added to the network, and the DHCP client program of the IPv4 equipment H starts to request the assignment of the IPv4 address of the DHCP server 20.

### (3) Identifier Assigning Program (Reservation Process)

As shown in FIG. 9, the network connecting section 8 receives a packet for requesting the assignment of the IPv4 address from the IPv4 equipment H (step S30). Then, the address managing section 11 checks whether or not a free IPv4 address remains, by searching the address management table 14 (step S31). Because no assignable IPv4 address is found, the communication capacity detecting section 9 detects whether or not the IPv4 equipment H can hold the IPv6 communication, based on the request packet (step S32).

The address managing section 11 searches the equipment to which the IPv4 address has been assigned and which can hold the IPv6 communication (step S33). According to the address management table 14, the equipments to which the IPv4 address has been assigned and which can hold the IPv6 communication are both the IPv4/IPv6 equipment E having the device identifier E and the IPv4/IPv6 equipment F having the device identifier F. Therefore, the address managing section 11 selects the equipment using the address whose expiration time is nearest (the IPv4/IPv6 equipment F) among those of these equipments (step S34).

The reserving section 21 reserves the IPv4 address=192.168.0.11 of the IPv4/IPv6 equipment F for the IPv4 equipment H as the sender-of-request equipment (step S35) That is, the reserving section 21 adds the row having the reservation No.=1, the device identifier=H to the reservation management table 15. In addition, when the equipment for which the IPv4 address is reserved is generated, the reserving section 21 adds the concerned row to the reservation management table 15.

The network connecting section 8 replies a standby notification to the IPv4 equipment as the sender-of-request equipment (step S36). The standby notification is the message “this equipment cannot be connected to the network because there is not enough IPv4 address. Please wait a little longer.” or the like, for example.

### (4) Identifier Assigning Program (Reservation Assigning Process 1)

As shown in FIG. 10, the deciding section 22 checks whether or not the expiration time 1000 of the reserved IPv4 address=192.168.0.11 passed (step S40). If the reservation expired, the address releasing section 12 releases the IPv4 address (deletes the address from the address management table 14)(step S41). The reserving section 21 cancels the reservation of the reserved equipment whose reservation No. is smallest (the IPv4 equipment H) from the reservation management table 15 (step S42). Then, the address assigning section 13 assigns the IPv4 address=192.168.0.11 to the IPv4 equipment H (step S43). The network connecting section 8 replies the assigned address information (step S44).

### (5) Identifier Assigning Program (Reservation Assigning Process 2)

As shown in FIG. 11, the network connecting section 8 receives a packet for requesting the release of IPv4 address from the IPv4/IPv6 equipment E as the equipment except the IPv4/IPv6 equipment F using the address whose expiration time is nearest (step S50). The address managing section 11 deletes (releases) the row of the IPv4/IPv6 equipment E from the address management table 14 (step S51).

The reserving section 21 searches whether or not there is the reserved equipment, by referring to the reservation management table 15 (step S52). Because there is the reserved equipment (the IPv4 equipment H at the top), the reserving section 21 deletes the reserved row (cancel the reservation) from the reservation management table 15 (step S53). The address assigning section 13 assigns the IPv4 address=192.168.0.10 of the IPv4/IPv6 equipment E to the IPv4 equipment H (step S54) The network connecting section 8 replies the assigned address information (step S55). The released IPv4 address of the equipment other than the equipment using whose expiration time is nearest is assigned by this process.

### (6) Identifier Assigning Program (Extension Denying Process)

As shown in FIG. 12, the network connecting section 8 receives a packet for requesting an extension of the expiration time of the IPv4 address from the IPv4/IPv6 equipment F as the equipment using the assignment whose expiration time is nearest (step S60). Normally, respective equipments to which the IP address has been assigned before expiration time passes transmit an extension request packet to the DHCP server.

The reserving section 21 searches whether or not there is the reserved equipment, by referring to the reservation management table 15 (step S61). Because there is the reserved equipment (the IPv4 equipment H at the top), the reserving section 21 replies the denial of extension request (step S62).

### 4. Fourth Exemplary Embodiment

An identifier assigning device in the fourth exemplary embodiment has a function of grasping an IPv4 communication using condition of the equipments connected to the network, and also has a function of detecting the equipments to which the IPv4 address has been assigned and which can also communicate by the IPv6, releasing the IPv4 address of the equipment, whose IPv4 communication rate is smallest, out of these equipments, and assigning this IPv4 address to the sender-of-request equipment when the equipment is connected newly in a situation that the assignable IPv4 address is not left.

### Configuration of Fourth Exemplary Embodiment

### (1) Identifier Assigning System

The identifier assigning system is implemented by the configuration in FIG. 1 or FIG. 5.

### (2) Identifier Assigning Device

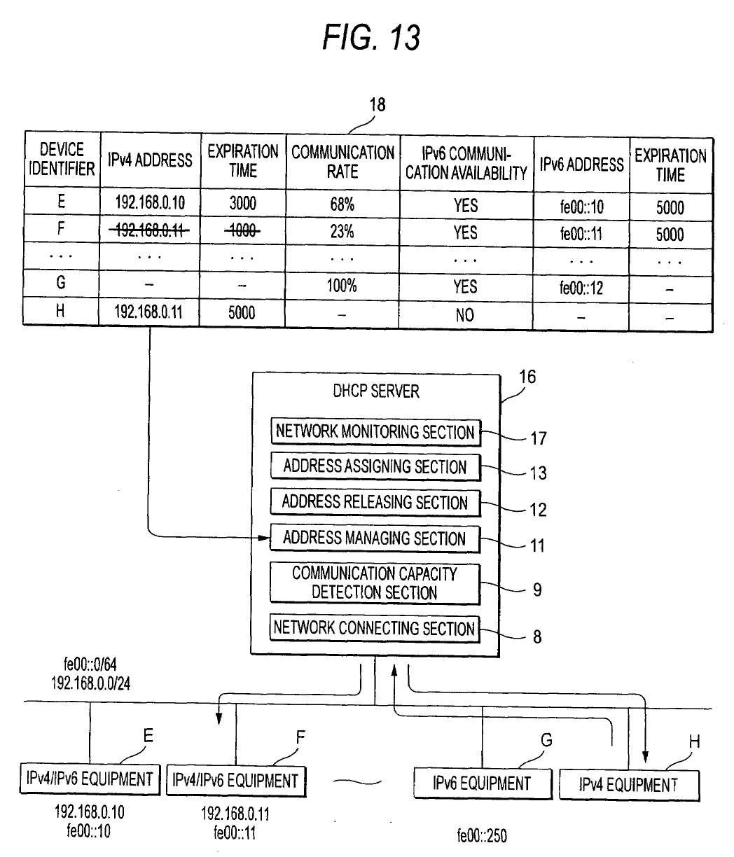

FIG. 13 is a functional block diagram showing an example of the identifier assigning device. A DHCP server 16 is an example of the identifier assigning device. The DHCP server 16 has a network monitoring section 17.

The network monitoring section 17 grasps a using condition of the IPv4 communication of respective equipments connected to the network. Here, the wording “using condition” stands for a rate of the IPv4 communication traffic to the overall IP communication traffic of respective equipments, for example. The network monitoring section 17 utilizes SNMP (Simple Network Management Protocol) as the method of acquiring the traffic. The network monitoring section 17 (an example of the monitoring section) is started as different process or thread from the identifier assigning program, and acquires the IPv4 communication traffic and the overall IP communication traffic from the equipments connected to the network at a predetermined time interval.

An address management table 18 contains a data item of a traffic rate. The network monitoring section 17 (an example of the calculating section) calculates a rate of the IPv4 communication based on the acquired IPv4 communication traffic and the overall IP communication traffic, and instructs the address managing section 11 to update a communication rate in the address management table 18.

### Operation of Fourth Exemplary Embodiment

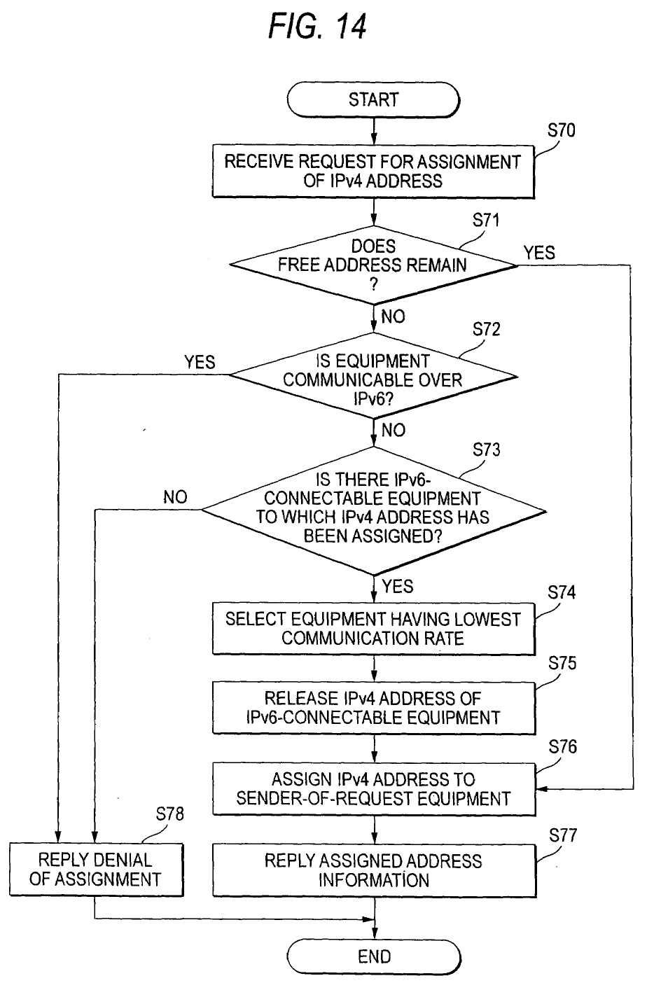

FIG. 14 is a flowchart showing an example of an operation of the identifier assigning device. An example of the operation will be explained with reference to FIG. 13 and FIG. 14 hereunder.

Assume that the DHCP server 16 has already assigned completely all IPv4 addresses. In this situation, the IPv4 equipment H is newly added to the network, and the DHCP client program of the IPv4 equipment H starts to request the assignment of the IPv4 address of the DHCP server 16.

### (3) Identifier Assigning Program

The network connecting section 8 receives a packet for requesting the assignment of IPv4 address from the IPv4 equipment H (step S70). Then, the address managing section 11 checks whether or a free IPv4 address is present, by searching the address management table 18 (step S71). Because the assignable IPv4 address is not found, the communication capacity detecting section 9 detects whether or not the IPv4 equipment H can hold the IPv6 communication, from the request packet (step S72).

Because the IPv4 equipment H cannot communicate by the IPv6, the address managing section 11 searches the address management table 18 to search the equipment to which the IPv4 address has been assigned and can hold the communication by the IPv6 (step S73). Also, the address managing section 11 selects the equipment whose IPv4 communication rate is lowest among these equipments (step S74).

Since the address management table 18 shows that the IPv4/IPv6 equipment F with the device identifier F has a lowest IPv4 communication rate, the address releasing section 12 releases (deletes) the IPv4 address=192.168.0.11 and the expiration time=1000 of the IPv4/IPv6 equipment F (step S75). Also, the address assigning section 13 assigns (registers) the released IPv4 address=192.168.0.11 and the expiration time=5000 to the IPv4 equipment H as the sender-of-request equipment (step S76). The network connecting section 8 replies the assigned address information to the IPv4 equipment H as the sender-of-request equipment (step S77).

### 5. Fifth Exemplary Embodiment

An identifier assigning device in the fifth exemplary embodiment has a function of receiving information about priority of the IPv4 address assignment from the equipments connected to the network, and also has a function of detecting the equipments to which the IPv4 address has been assigned and which can also communicate by the IPv6, releasing the IPv4 address of the equipment whose priority is lowest out of these equipments, and assigning this IPv4 address to the sender-of-request equipment when the equipment is connected newly in a situation that the assignable IPv4 address is not left.

### Configuration of Fifth Exemplary Embodiment

### (1) Identifier Assigning System

The identifier assigning system can be implemented by the configuration in FIG. 1 or FIG. 5.

### (2) Identifier Assigning Device

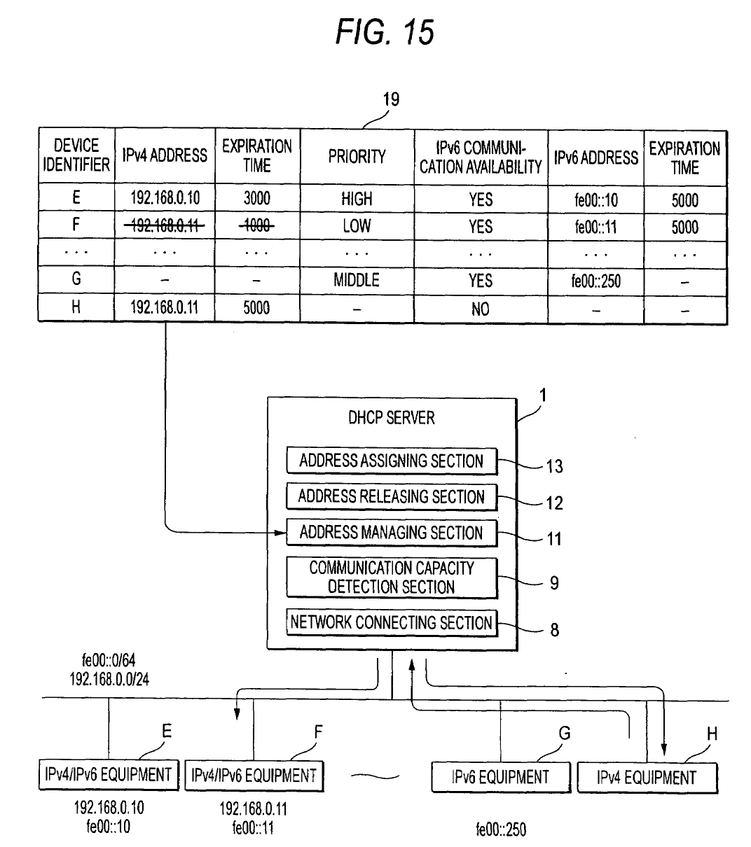

FIG. 15 is a functional block diagram showing an example of the identifier assigning device. The DHCP server 1 has an address management table 19 containing a data item concerning the priority of the assignment of the IPv4 address. Here, the term “priority” is a degree of importance of each equipment. There are three types of priorities, i.e., high, middle, and low priorities.

### Operation of Fifth Exemplary Embodiment

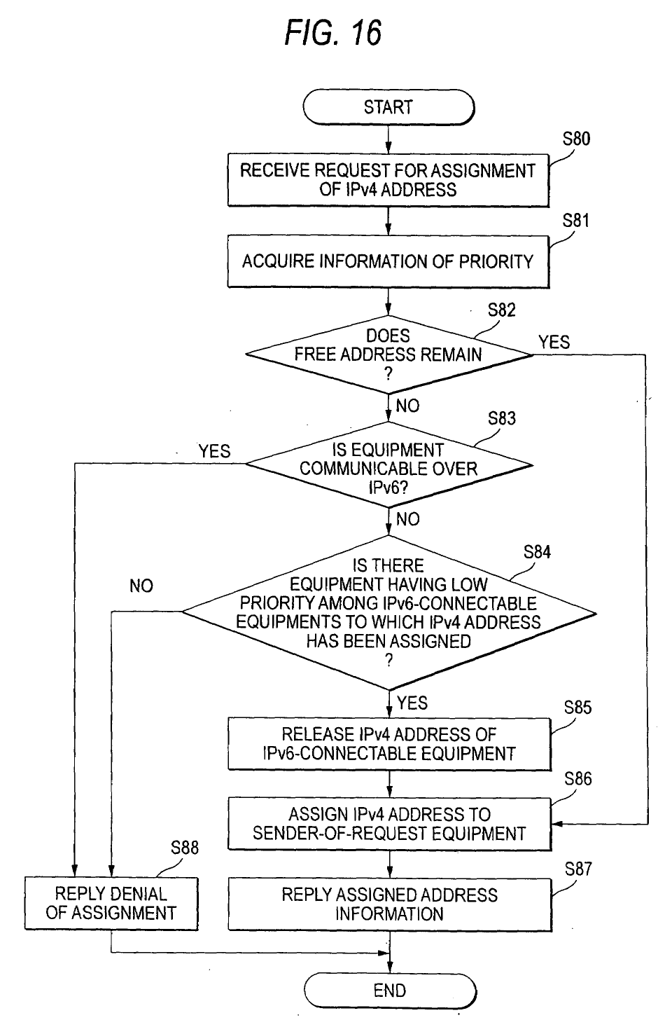

FIG. 16 is a flowchart showing an example of an operation of the identifier assigning device. An example of the operation will be explained with reference to FIG. 15 and FIG. 16 hereunder.

Assume that the DHCP server 1 has already assigned completely all IPv4 addresses. In this situation, the IPv4 equipment H is newly added to the network, and the DHCP client program of the IPv4 equipment H starts to request the assignment of the IPv4 address of the DHCP server 1.

### (3) Identifier Assigning Program

The network connecting section 8 receives a packet for requesting the assignment of the IPv4 address from the IPv4 equipment H (step S80). The network connecting section 8 acquires information of the priority from the received IPv4 address request message, and instructs the address managing section 11 to register this priority in the address management table 19 (step S81). In this case, a function of setting the priority of the IPv4 address assignment among the equipments connected to the network manually may be employed.

Then, the address managing section 11 searches the address management table 19 to check whether or not a free IPv4 address is present (step S82). Because there is no assignable IPv4 address, the communication capacity detecting section 9 detects whether or not the IPv4 equipment H can hold the IPv6 communication, from the request packet (step S83).

Because the IPv4 equipment H cannot communicate by the IPv6, the address managing section 11 searches the address management table 19 to search the equipment whose priority is low among the equipments to which the IPv4 address has been assigned and which can also communicate by the IPv6 (step S84). In this case, if the equipment whose priority is low is not detected, the equipment whose priority is middle may be selected.

The address management table 19 shows that the equipment whose priority is low among the equipments to which the IPv4 address has been assigned and which can also communicate by the IPv6 is the IPv4/IPv6 equipment F having the device identifier F. Therefore, the address releasing section 12 releases the IPv4 address=192.168.0.11 and the expiration time=1000 (step S85). The address assigning section 13 assigns the released IPv4 address to the IPv4 equipment H as the sender-of-request equipment (step S86). The network connecting section 8 replies the assigned address information to the IPv4 equipment H as the sender-of-request equipment (step S87).

### 6. Sixth Exemplary Embodiment

An identifier assigning device in the sixth exemplary embodiment has a function of calculating an occupation rate of the already-assigned IPv4 address in the overall assignable IPv4 addresses after the device received the IPv4 address assignment request, then checking whether or not the sender-of-request equipment can communicate by the IPv6 if this rate exceeds a predetermined rate, and then denying a request for assignment of the IPv4 address when this equipment can hold the IPv6 communication.

### Configuration of Sixth Exemplary Embodiment

### (1) Identifier Assigning System

The identifier assigning system is implemented by the configuration in FIG. 15 or FIG. 14.

### (2) Identifier Assigning Device

The identifier assigning device is implemented by any one of configurations in FIG. 3, FIG. 6, FIG. 13, and FIG. 15.

### Operation of Sixth Exemplary Embodiment

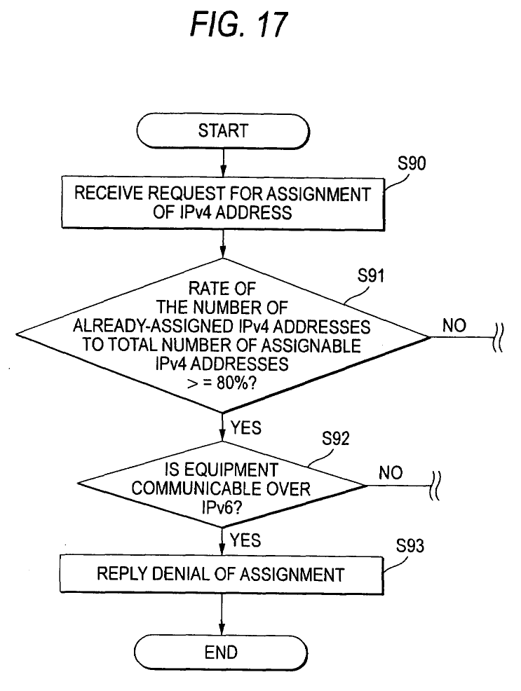

FIG. 17 is a flowchart showing an example of an operation of the identifier assigning device. An example of the operation will be explained with reference to FIG. 15 and FIG. 17 hereunder.

### (3) Identifier Assigning Program

The network connecting section 8 receives a request for assignment of the IPv4 address from the IPv4/IPv6 equipment E that can communicate by both the IPv4 and the IPv6 (step S90). In this case, the network connecting section 8 may receive a request for extension of the expiration time.

In step S91, the address managing section 11 (an example of a checking section) refers to the address management table 19, then calculates an occupation rate of the number of already-assigned IPv4 addresses to the total number of assignable IPv4 addresses, and then checks whether or not the calculated result exceeds 80%. A threshold value (80% in the present exemplary embodiment) of this calculated result is set in advance. The identifier assigning program performs a process of assigning the IPv4 address if the calculated result is not more than 80%.

If the calculated result is more than 80%, the communication capacity detecting section 9 detects whether or not the IPv4/IPv6 equipment E can communicable by the IPv6 (step S92). Because the IPv4/IPv6 equipment E is the equipment that can also communicate by the IPv6, the network connecting section 8 (an example of a denying section) replies the denial of assignment to the IPv4/IPv6 equipment E (step S93).

### 7. Seventh Exemplary Embodiment

An identifier assigning device in the seventh exemplary embodiment has a function of calculating an occupation rate of the already-assigned IPv4 address in the overall assignable IPv4 addresses after this device received a request for assignment of the IPv4 address, and then starting a change of destination of the IPv4 address assignment when this rate exceeds a predetermined rate and the sender-of-request equipment cannot hold the IPv6 communication. In other words, the identifier assigning device starts to assign the IPv4 address of the equipment, which can communicate by both the IPv4 and the IPv6, to the equipment that can communicate by the IPv4 only even in a situation that the assignable IPv4 address has not been exhausted yet.

### Configuration of Seventh Exemplary Embodiment

### (1) Identifier Assigning System

The identifier assigning system is implemented by the configuration in FIG. 1 or FIG. 5.

### (2) Identifier Assigning Device

The identifier assigning device is implemented by any one of configurations in FIG. 3, FIG. 6, FIG. 13, and FIG. 15.

### Operation of Seventh Exemplary Embodiment

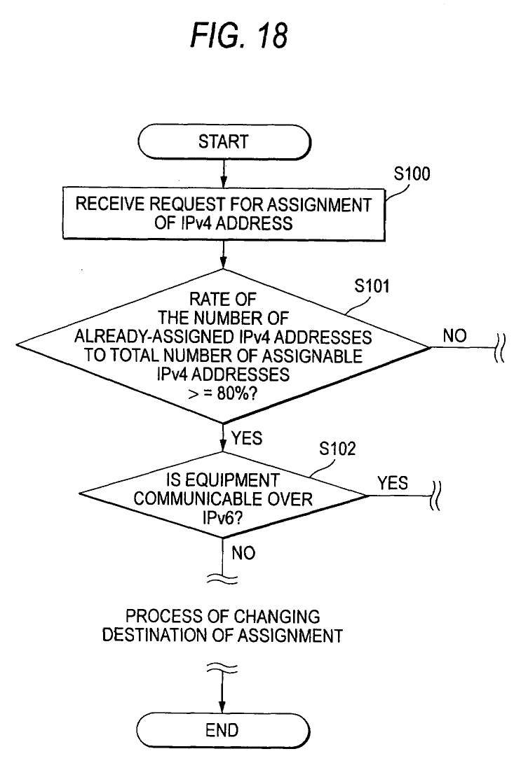

FIG. 18 is a flowchart showing an example of an operation of the identifier assigning device. An example of the operation will be explained with reference to FIG. 15 and FIG. 18 hereunder.

### (3) Identifier Assigning Program

The network connecting section 8 receives a request for assignment of the IPv4 address from the IPv4 equipment H (step S100). In this case, the network connecting section 8 may receive a request for extension of the expiration time.

In step S101, the address managing section 11 (an example of a checking section) refers to the address management table 19, then calculates an occupation rate of the number of already-assigned IPv4 addresses to the total number of assignable IPv4 addresses, and then checks whether or not the calculated result exceeds 80%. A threshold value (80%) of this calculated result is set in advance. The identifier assigning program performs a process of assigning the free IPv4 address if the calculated result is not more than 80%.

If the calculated result is more than 80%, the communication capacity detecting section 9 detects whether or not the IPv4 equipment H can communicable by the IPv6 (step S102). Because the IPv4 equipment H is the equipment that cannot communicate by the IPv6, the address assigning section 13 assigns the IPv4 address of the equipment, which can communicate by both the IPv4 and the IPv6, to the IPv4 equipment H. The address assigning section 13 executes this process of changing the destination of assignment shown in the first exemplary embodiment to the fifth exemplary embodiment.

Further, other exemplary embodiments will be described hereunder. In this case, some of these embodiments may be contained in the above mentioned exemplary embodiments.

In one mode of the exemplary embodiment, an identifier assigning device includes an accepting section for accepting a request for assignment of an identifier corresponding to a first communicating section from a first equipment; a detecting section for detecting whether or not the first equipment for requesting the assignment of the identifier corresponding to the first communicating section can communicate by the second communicating section; another detecting section for detecting a second equipment to which the identifier corresponding to the first communicating section has been assigned and which can communicate by the second communicating section when the detecting section that the first equipment cannot communicate by the second communicating section; a releasing section for releasing the identifier (i) assigned to the second equipment that the another detecting section detected and (ii) corresponding to the first communicating section; and an assigning section for assigning the identifier (i) released by the releasing section and (ii) corresponding to the first communicating section to the first equipment that the accepting section accepted. According to this mode, the equipment capable of communicating only by the first communicating section can acquire the identifier corresponding to the first communicating section and can communicate by the first communicating section.

In another mode of the above exemplary embodiment, an identifier assigning device includes a checking section for calculating an occupation rate of the number of already-assigned identifiers corresponding to the first communicating section to a total number of assignable identifiers corresponding to the first communicating section and checking whether or not the rate exceeds a predetermined rate; the detecting section for detecting whether or not a first equipment that makes a request for assignment of the identifier corresponding to the first communicating section can communicate by a second communicating section when the checking section checked that the rate exceeds the predetermined rate; and a denying section for denying the request for assignment of the identifier corresponding to the first communicating section when the detecting section detected that the first equipment can communicate by the second communicating section. According to this mode, the equipment capable of communicating only by the first communicating section can acquire the identifier corresponding to the first communicating section before other equipments capable of communicating by the second communicating section.

In still another mode of the exemplary embodiment, an identifier assigning device includes a checking section for calculating an occupation rate of the number of already-assigned identifiers corresponding to the first communicating section to a total number of assignable identifiers corresponding to the first communicating section and checking whether or not the rate exceeds a predetermined rate; the detecting section for detecting whether or not a first equipment that makes a request for assignment of the identifier corresponding to the first communicating section can communicate by a second communicating section when the checking section checked that the rate exceeds the predetermined rate; and the another detecting section for detecting a second equipment to which the identifier corresponding to the first communicating section has been assigned and can communicate by the second communicating section when the detecting section detected that the first equipment cannot communicate by the second communicating section. According to this mode, the equipment capable of communicating only by the first communicating section can acquire the identifier corresponding to the first communicating section before other equipments capable of communicating by the second communicating section.

In this case, the first communicating section and the second communicating section are not limited to the communicating section that uses the IPv4 and the IPv6, and can be applied to other communicating section. For example, the first communicating section and the second communicating section can be applied to the radio communication, the satellite communication, the mobile communication, and the like.

The present invention can be utilized as the PC, the server, the router, the communication board, etc. each of which has such a function that permits the equipments connected to the network to acquire the IPv4 address without fail and communicate by the IPv4 in the mixed network that includes the IPv4 equipment, the IPv4/IPv6 equipment, and others.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An identifier assigning device comprising:
an accepting section that accepts a request from a first equipment for assigning an identifier of a first type to the first equipment, the first equipment configured to communicate using an identifier of the first type;
a releasing section that releases an identifier of the first type assigned to a second equipment, wherein an identifier of a second type is also assigned to the second equipment and the second equipment is configured to communicate using any of (i) the identifier of the first type assigned thereto and (ii) the identifier of the second type assigned thereto; and
an assigning section that assigns the identifier of the first type released from the second equipment by the releasing section, to the first equipment from which the accepting section accepts the request.

2. The identifier assigning device according to claim 1, further comprising:
a first detecting section that detects the second equipment,
wherein the releasing section releases the identifier of the first type assigned to the second equipment detected by the first detecting section.

3. The identifier assigning device according to claim 2, further comprising:
a determining section that determines as to whether or not an assignable identifier of the first type remains,
wherein, when the determining section decides that no assignable identifier remains, the first detecting section detects the second equipment.

4. The identifier assigning device according to claim 2, further comprising:
a second detecting section that detects as to whether or not the first equipment is configured to communicate using an identifier of the second type,
wherein, when the second detecting section detects that the first equipment is unable to communicate using any identifier of the second type, the first detecting section detects the second equipment.

5. The identifier assigning device according to claims 2, further comprising:
a managing section that manages information which comprises (i)the identifier of the first type assigned to the first equipment and (ii) information as to whether or not the first equipment is configured to communicate using an identifier of the second type, in association with each other;
wherein, based on the information managed by the managing section, the first detecting section detects the second equipment.

6. The identifier assigning device according to claims 2, further comprising:
a notifying section that notifies the second equipment of information which indicates that the releasing section is to release the identifier of the first type assigned to the second equipment.

7. The identifier assigning device according to claims 2,
wherein, when the first detecting section detects a plurality of second equipments, the first detecting section specifies, from among the detected second equipments, a second equipment to which assigned is an identifier of the first type having at least one of:
(i) a nearest expiration time among expiration times of identifiers of the first type assigned to the detected second equipments, and
(ii) a lowest usage priority among usage priorities of the identifiers of the first type assigned to the detected second equipments.

8. The identifier assigning device according to claims 2, further comprising:
a monitoring section that monitors a first traffic of the second equipment communicating using the identifier of the first type and monitors a second traffic of the second equipment communicating using the identifier of the second type; and
a calculating section that calculates an occupation rate of the first traffic to sum of the first traffic and the second traffic;
wherein, when the first detecting section detects a plurality of second equipments, the detecting section detects a second equipment having a lowest occupation rate, calculated by the calculating section among occupation rates of the detected second equipments.

9. The identifier assigning device according to claims 2, further comprising:
an inquiring section that inquires of the detected second equipment as to whether or not the detected second equipment needs to communicate using the identifier of the first type;
wherein, based on a result inquired by the inquiring section, the releasing section releases the identifier of the first type from the detected second equipment.

10. The identifier assigning device according to claims 2, further comprising:
an inquiring section that inquires of the detected second equipment as to whether or not the detected second equipment needs to communicate using the identifier of the first type;
wherein, based on a result inquired by the inquiring section, the detecting section detects a third equipment which is configured to communicate using any of (i) an identifier of the first type assigned thereto and (ii) an identifier of the second type assigned thereto.

11. The identifier assigning device according to claims 2, further comprising:
a reserving section that reserves the identifier of the first type assigned to the detected second equipment.

12. The identifier assigning device according to claims 2, further comprising:
a judging section that judges whether or not the expiration time of the identifier of the first type assigned to the detected second equipment has passed;
wherein, when the judging section judges that the expiration time of the identifier of the first type assigned to the detected second equipment has passed, the releasing section releases the identifier of the first type to the detected second equipment.

13. The identifier assigning device according to claims 2,
wherein the first type is IPv4, and the second type is IPv6.

14. The identifier assigning device according to claim 2, wherein the identifiers is an IP addresses.

15. An identifier assigning system comprising:
a first equipment that is configured to communicate using an identifier of a first type;
a second equipment that is configured to communicate using any of (i) an identifier of the first type assigned thereto and (ii) an identifier of an second type assigned thereto;
an accepting section that accepts a request from the first equipment for assigning the identifier of the first type to the first equipment;
a releasing section that releases the identifier of the first type assigned to the second equipment, wherein the identifier of the second type is also assigned to the second equipment; and
an assigning section that assigns the identifier of the first type released from the second equipment by the releasing section, to the first equipment from which the accepting section accepts the request.

16. A computer readable medium storing a program causing a computer to execute a process for assigning an identifier, the process comprising:
accepting a request from a first equipment for assigning an identifier of a first type to the first equipment, the first equipment configured to communicate using an identifier of the first type;
releasing an identifier of the first type assigned to a second equipment, wherein an identifier of a second type is also assigned to the second equipment and the second equipment is configured to communicate using any of (i) the identifier of the first type assigned thereto and (ii) the identifier of the second type assigned thereto; and
assigning the identifier of the first type released from the second equipment by the releasing section, to the first equipment from which the accepting section accepts the request.

17. An information processing method for assigning an identifier comprising:
accepting a request from a first equipment for assigning an identifier of a first type to the first equipment, the first equipment configured to communicate using an identifier of the first type;
releasing an identifier of the first type assigned to a second equipment, wherein an identifier of a second type is also assigned to the second equipment and the second equipment is configured to communicate using any of (i) the identifier of the first type assigned thereto and (ii) the identifier of the second type assigned thereto; and
assigning the identifier of the first type released from the second equipment by the releasing section, to the first equipment from which the accepting section accepts the request.
